(19) United States
(12) Patent Application Publication
(10) Pub. No.: US 2019/0029433 A1
(43) Pub. Date: Jan. 31, 2019

(54) ARM POUCH

(71) Applicant: Leonard Locurto, Cumming, GA (US)

(72) Inventor: Leonard Locurto, Cumming, GA (US)

(21) Appl. No.: 16/026,043

(22) Filed: Jul. 2, 2018

Related U.S. Application Data
(60) Provisional application No. 62/527,037, filed on Jun. 30, 2017.

(51) Int. Cl. A47C 16/00; F16M 13/04

(52) U.S. Cl. CPC A47C 16/00; F16M 13/04

(57) ABSTRACT

Implementation of an arm pouch are provided. In some implementations, the arm pouch is provided for holding, resting, and/or maintaining a person's arms in a folded position. In some implementations, the arm pouch comprises a front panel, a back panel, an interior, an expanding portion, and an adjustment flap.

In some implementations, a method of using the arm pouch comprises inserting a person's arms into the folded position within the interior of the arm pouch, and adjusting the adjustment flap to fit the interior of the arm pouch to the person's arms in the folded position.

### CROSS REFERENCE TO RELATED APPLICATION

This application claims the benefit of U.S. Patent Application Ser. No. 62/527,037, which was filed on Jun. 30, 2017, and is incorporated herein by reference in its entirety.

### TECHNICAL FIELD

This disclosure relates to implementations of an arm pouch.

### BACKGROUND

As shown in FIG. 1, when sitting in close quarters, a person may fold his or her arms. For example, a person sitting in the middle seat on a plane may fold his or her arms for comfort or to maintain personal space. Keeping the arms folded requires effort, and if the person falls asleep with his or her arms folded, the arms are likely to become unfolded.

### BRIEF DESCRIPTION OF THE DRAWINGS

FIG. 1 illustrates an example of a person folding his or her arms.

FIGS. 2A-2E illustrate implementations of an example arm pouch according to the present disclosure.

FIGS. 3A-3B illustrate implementations of example fabrication patterns of the arm pouch of FIGS. 2A-2E according to the present disclosure.

FIGS. 4A-4B illustrate implementations of an example use of the arm pouch of FIGS. 2A-2E according to the present disclosure.

FIGS. 5A-5F illustrate another implementations of an arm pouch according to the present disclosure.

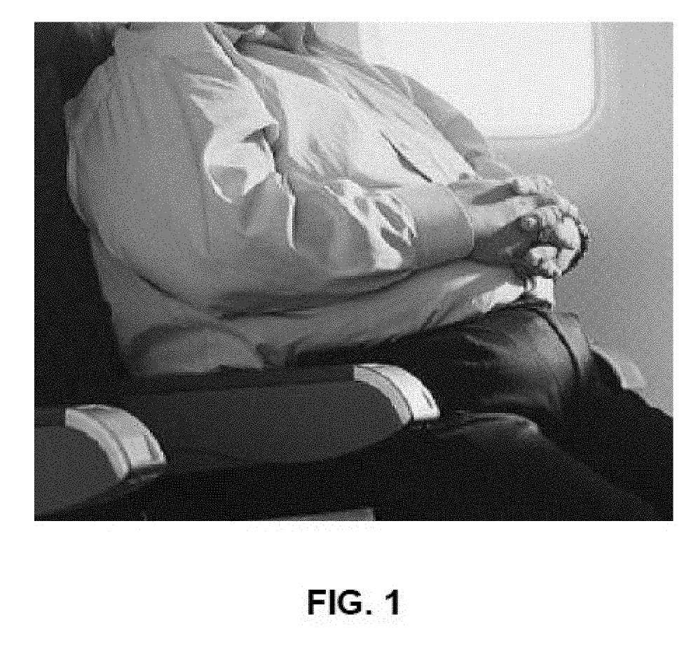

### DETAILED DESCRIPTION

Implementations of an arm pouch are provided. In some implementations, the arm pouch is provided for a user's arms. In some implementations, the arm pouch is provided for holding, resting, and/or maintaining a user's arms in a folded position. In some implementations, the arm pouch comprises a front panel, a back panel, an interior, an expanding portion, and an adjustment flap.

In some implementations, a method of using the arm pouch comprises inserting a user's arms within the interior of the arm pouch, and adjusting the adjustment flap, for example, to fit the interior of the arm pouch to the user's arms (e.g., in the folded position).

In some implementations, the arm pouch is configured to provide both an expanding or stretching adjustment and a manual adjustment of the length of the back panel (or “back side”).

In some implementations, the expanding adjustment and the manual adjustment of the length of the back side is configured to adjust to fit a user's (i.e., a user's) arms.

In some implementations, the expanding portion of the arm pouch is configured to provide the expanding adjustment of the back side.

In some implementations, the adjustment flap of the arm pouch is configured to provide the manual adjustment of the back side.

In some implementations, the back side of the arm pouch comprises a first layer and a second layer.

In some implementations, the first, inner layer comprises the expanding portion of the arm pouch.

In some implementations, the second, outer layer comprises the adjustment flap of the arm pouch.

In some implementations, the arm pouch is configured to cradle a person's arms.

In some implementations, the arm pouch is configured to assist a person to maintain a folded arm position.

In some implementations, the arm pouch is configured to keep a person's arms folded in place.

In some implementations, the arm pouch is configured to keep a person's arms folded in place even when the person is asleep.

In some implementations, the arm pouch is configured to mimic how a person crosses his or her arms to have them rest.

In some implementations, the arm pouch is configured to allow a person to relax his or her arms by resting them in the arm pouch.

In some implementations, the arm pouch is configured to use the natural weight of a person's arms to push outwards on the walls of the arm pouch to hold the person's arms in place naturally against the person's body.

In some implementations, the arm pouch is configured to allow the person's arms to rest on the bottom portion of the arm pouch.

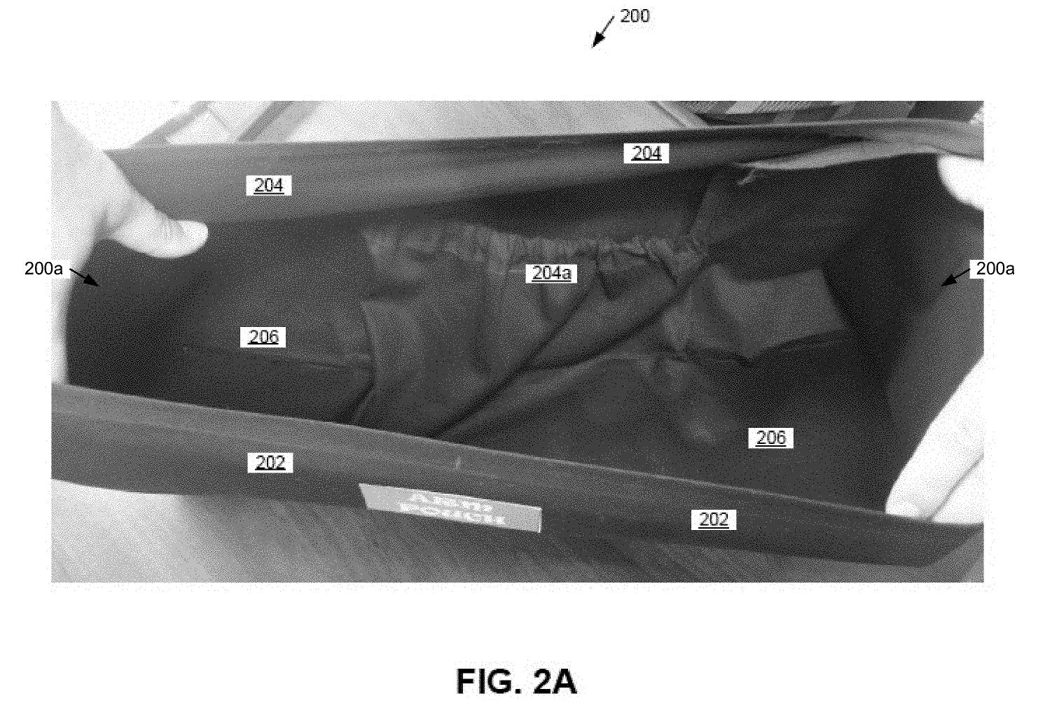

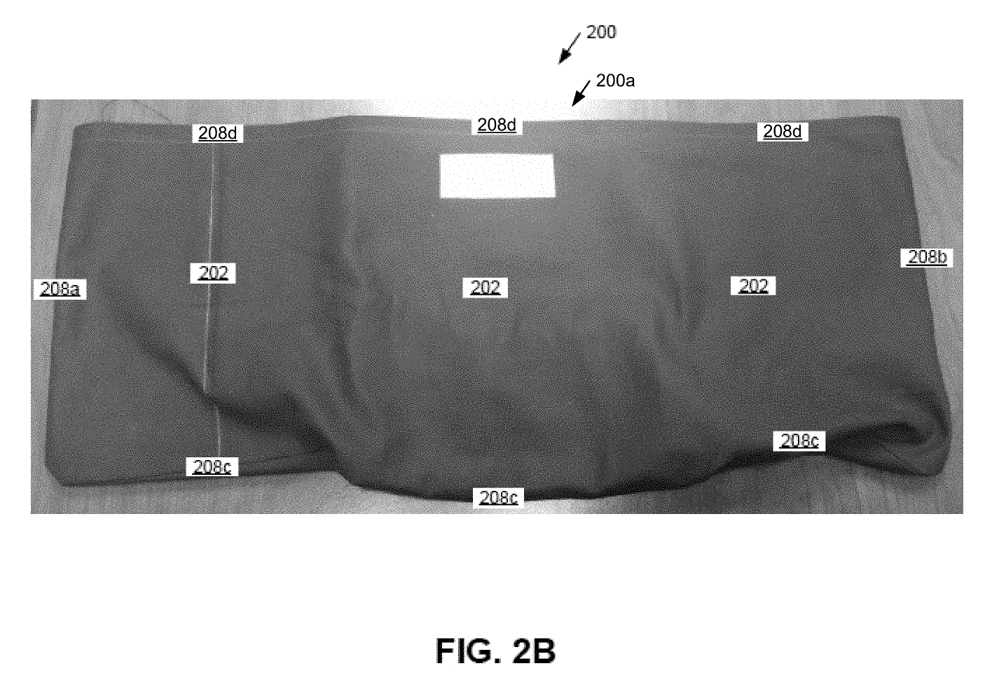

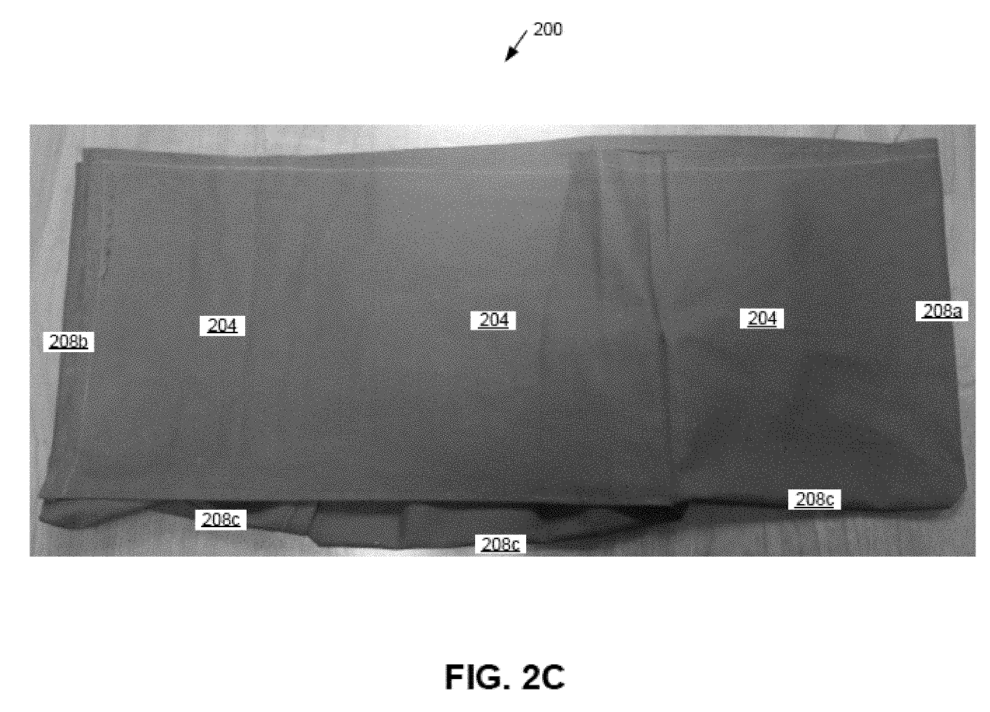

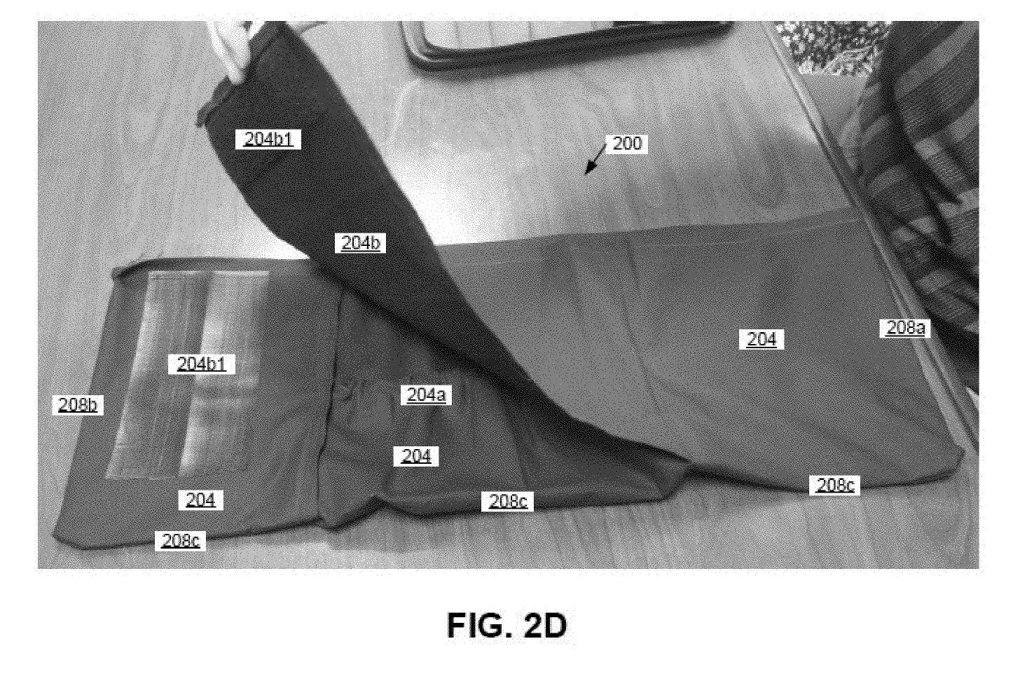

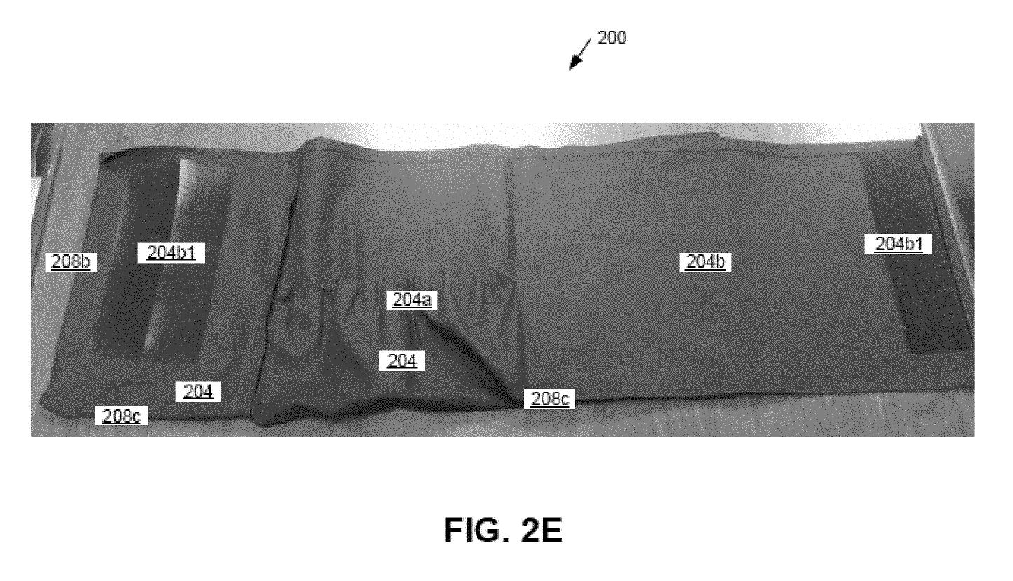

FIGS. 2A-2E illustrate implementations of an example arm pouch 200 according to the present disclosure. More specifically, FIG. 2A illustrates a top view of the arm pouch 200. FIG. 2B illustrates a front view of the arm pouch 200. FIGS. 2C-2E illustrate back views of the arm pouch 200.

In some implementations, the arm pouch 200 comprises a front panel (or “front side” or “first side”) 202, a back panel (or “back side” or “second side”) 204 opposite the front panel, an interior 206, an expanding portion 204a, and an adjustment flap 204b.

In some implementations, the first side 202 comprises a piece of material extending from a left side 208a to a right side 208b and a top side 208d to a bottom side 208c.

In some implementations, the second side 204 comprises a piece of material extending from a left side 208a to a right side 208b and a top side 208d to a bottom side 208c.

As shown for example in FIGS. 2A, 2D, and 2E, in some implementations, the back side 204 of the arm pouch 200 comprises an expandable portion 204a. In some implementations, the expandable portion 204a extends at least partially between the left side 208a and the right side 208b of the arm pouch 200.

In some implementations, the expandable portion 204a is configured to help fit the interior 206 of the arm pouch 200 to a person's folded arms.

In some implementations, the expandable portion 204a is configured to flexibly expand the back side 204 of the arm pouch 200. In some implementations, the expandable portion 204a is configured to flexibly contract the back side 204 of the arm pouch 200.

In some implementations, the expandable portion 204a comprises an elastic material.

In some implementations, the expandable portion 204a comprises any other suitable material.

As shown for example in FIGS. 2A, 2D, and 2E, in some implementations, the back side 204 of the arm pouch 200 further comprises an adjustment flap 204b. In some implementations, the adjustment flap 204b extends at least partially between the left side 208a and the right side 208b of the arm pouch 200.

In some implementations, the adjustment flap 204b is configured to adjust the length of the back side 204 between the left side 208a and the right side 208b.

In some implementations, the adjustment flap 204b is configured to adjust the length of the interior 206 between the left side 208a and the right side 208b.

In some implementations, the adjustment flap 204b is configured to adjust the fit of the arm pouch 200 based on the size of a user's (i.e., a person's) folded arms.

In some implementations, the adjustment flap 204b is configured to adjust the arm pouch 200 to allow a user's folded arms to comfortably fit in the interior 206 of the arm pouch 200.

As shown for example in FIG. 2D, in some implementations, the adjustment flap 204b comprises attaching portions 204b1. In some implementations, the attaching portions 204b1 are configured to attach the adjustment flap 204b to the back side 204. In some implementations, the attaching portions 204b1 are a hook and loop attachment such as Velcro. In some implementations, the attaching portions 204b1 are any other suitable attachment mechanism such as a zipper, snaps, buttons, magnets or other recloseable fasteners or any other attachment or fastening technology existing or developed in the future.

In some implementations, the arm pouch 200 is configured to provide an expanding adjustment and a manual adjustment of the length of the back side 204 between the left side 208a and the right side 208b. In some implementations, the expanding adjustment and the manual adjustment of the length of the back side 204 is configured to adjust to fit a user's folded arms. In some implementations, the expanding portion 204a of the arm pouch 200 is configured to provide the expanding adjustment of the back side 204. In some implementations, the adjustment flap 204b of the arm pouch 200 is configured to provide the manual adjustment of the back side 204.

In some implementations, the back side 204 of the arm pouch comprises a first layer and a second layer. In some implementations, the first layer comprises the expanding portion 204a of the arm pouch 200. In some implementations, the first layer is an inner layer with respect to the interior 206 of the arm pouch 200.

In some implementations, the second layer comprises the adjustment flap 204b of the arm pouch 200. In some implementations, the second layer is an outer layer with respect to the interior 206 of the arm pouch 200.

In some implementations, the attaching portions 204b1 are configured to allow the adjustment flap 204b to be unattached from and attached to various positions of the second layer. In some implementations, the adjustment flap 204b can be unattached from and attached to the second layer to provide a manual adjustment of the length of the back panel 204 between the left side 208a and the right side 208b of the arm pouch 200.

In some implementations, the front side 202 and the back side 204 are connected along a left side 208a, a right side 208b, and a bottom side 208c with respect to the front side 202 thereby forming the interior 206. In some implementations, the arm pouch 200 further comprises an opening 200a to the interior 206. In some implementations, the opening 200a is defined along a top side 208d of the arm pouch 200 between the front side 202 and the back side 204.

In some implementations, the front panel 202, back panel 204, and interior 206 is configured to form a pouch-like shape. For example, in some implementations, the arm pouch 200 comprises a rectangular pouch shape. In some implementations, the arm pouch 200 comprises any other suitable pouch-like shape.

In some implementations, the interior 206 is configured to allow a person (i.e., a user) to insert his or her arms in a folded position into the interior 206. In some implementations, the interior 206 is configured to allow a person to rest his or her arms in a folded position in the interior 206. In some implementations, the interior 206 is configured to keep a person's arms in a folded position in the interior 206.

In some implementations, the arm pouch 200 is configured so that the back side 204 positions adjacent to the person's body when the person's arms in the folded position are positioned in the interior 206 of the arm pouch 200.

In some implementations, the above-discussed folded position of the person's arms comprises at least a portion of the person's arms positioned adjacently together in front of the person's body with the person's arms at least partially bent at the elbows.

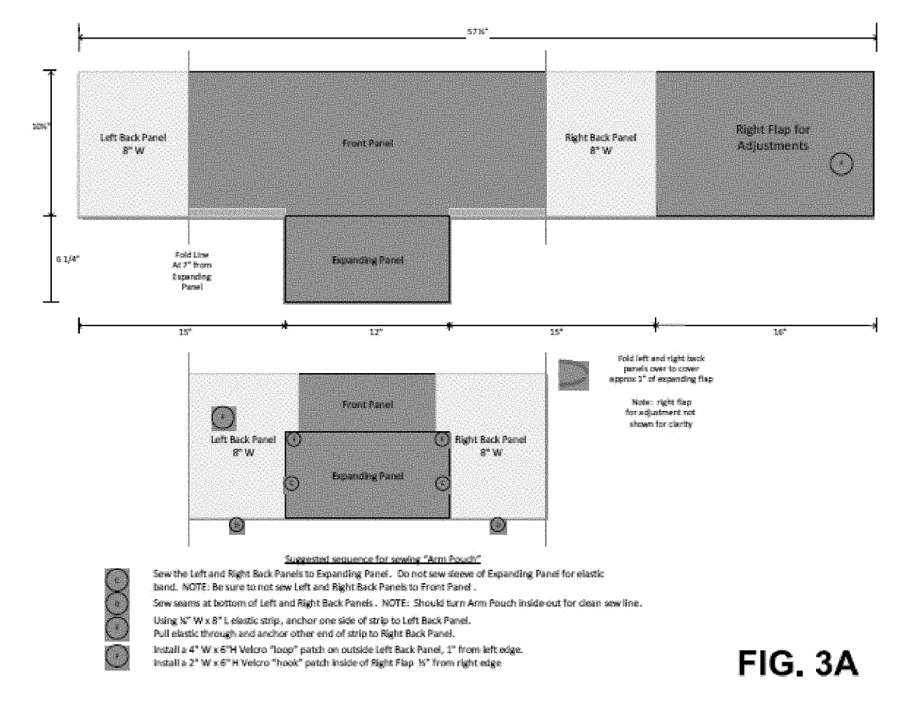

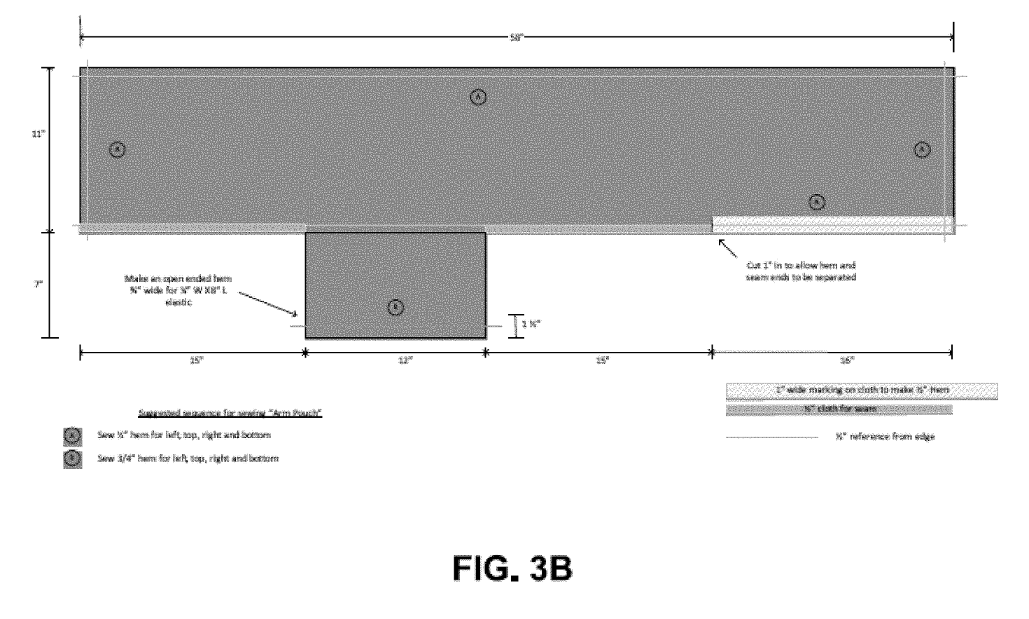

FIGS. 3A-3B illustrate implementations of example fabrication patterns of the arm pouch 200 of FIGS. 2A-2E according to the present disclosure.

In some implementations, the example fabrication patterns of the arm pouch 200 shown in FIGS. 3A-3B comprise the same or similar elements and features to those described above for FIGS. 2A-2E.

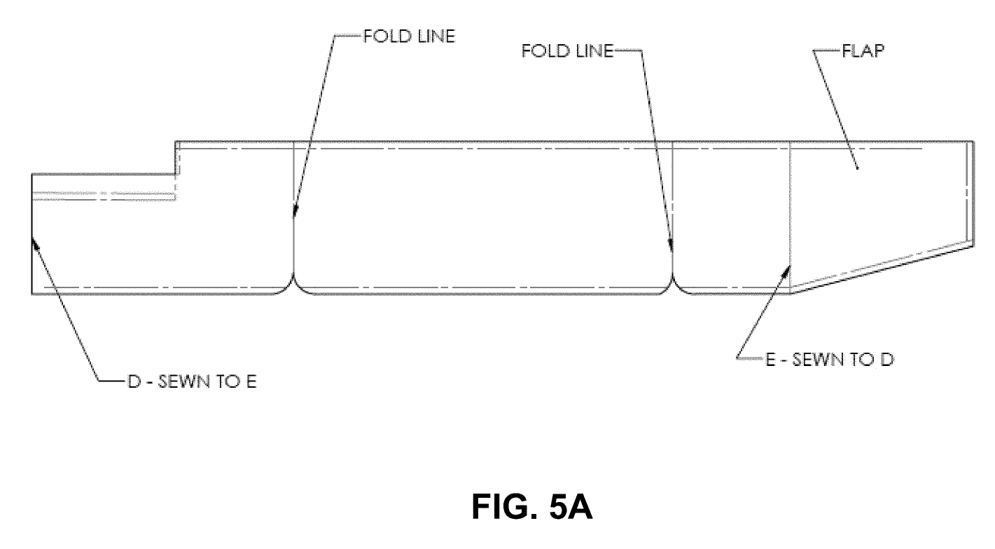

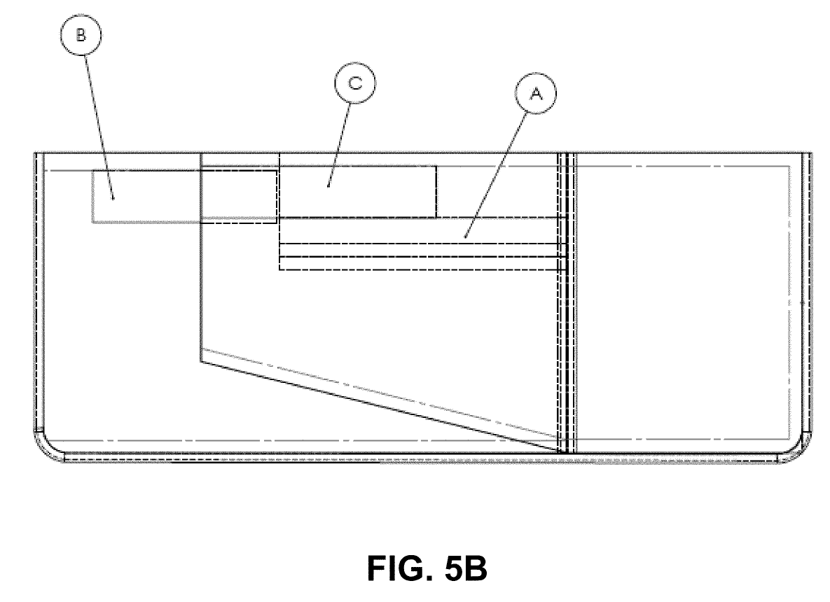

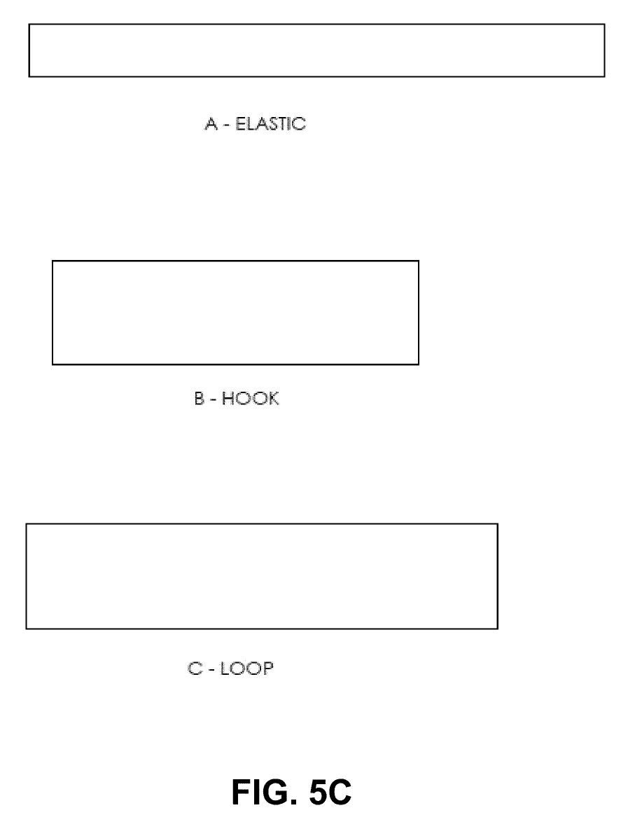

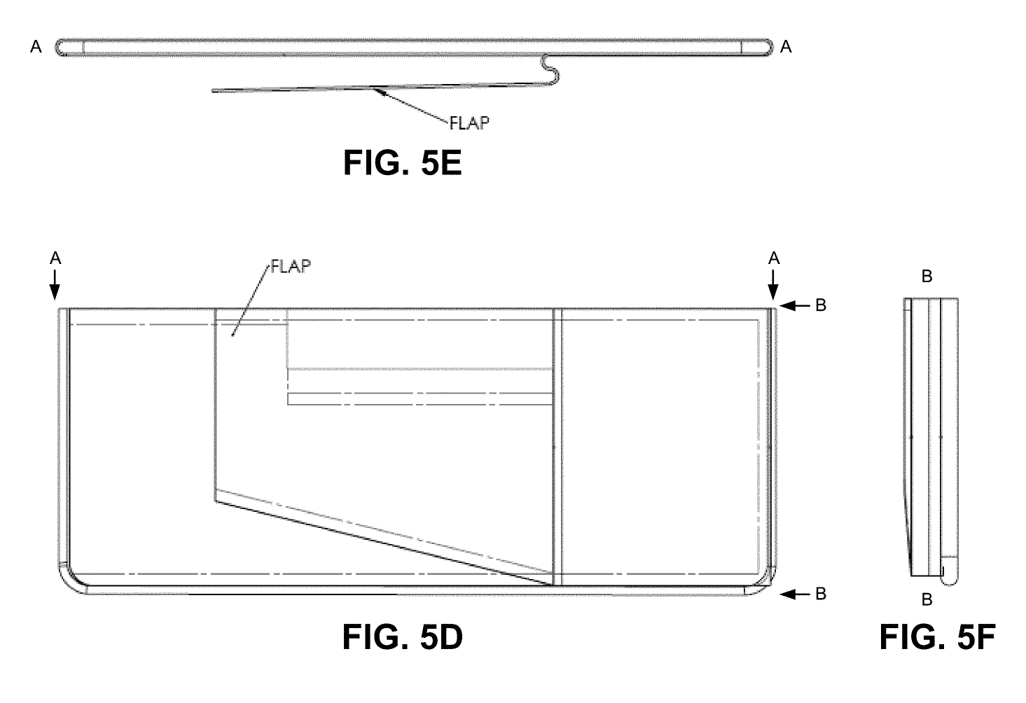

FIGS. 5A-5F illustrate another implementations of an arm pouch 500 according to the present disclosure.

FIG. 5A is an interior view of the fabrication pattern of the arm pouch. FIGS. 5B and 5D are back views of the arm pouch. FIG. 5C is a component view of the fabrication pattern shown in FIG. 2B. FIG. 5E is a top view of the arm pouch. FIG. 5F is a side view of the arm pouch.

In some implementations, the example fabrication patterns of the arm pouch shown in FIGS. 5A-5F comprise the same or similar elements and features to those described above for FIGS. 2A-2E.

In some implementations, the components of the arm pouch, such as the front side 202 and the back side 204, are composed of a flexible material.

In some implementations, the components of the arm pouch 200, 500 are composed of a light weight fabric.

In some implementations, the light weight fabric is a cotton twill. In some implementations, the light weight fabric is a polyester-cotton blend.

In some implementations, the light weight fabric is any other suitable fabric.

In some implementations, the components of the arm pouch are composed of any other suitable material.

In some implementations, the components of the arm pouch 200 can have any suitable appearance.

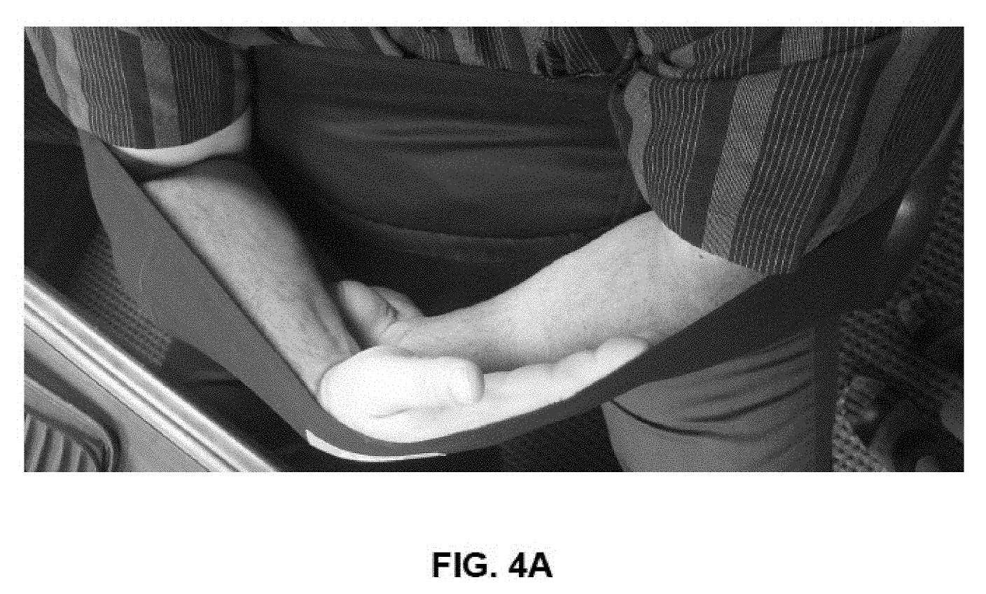

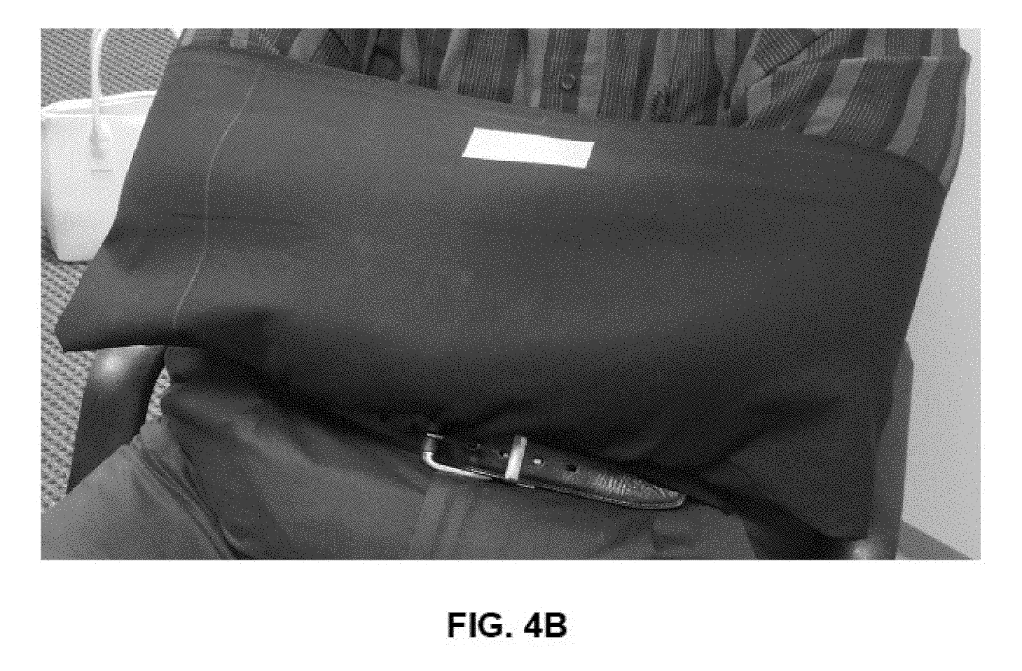

FIGS. 4A-4B illustrate implementations of an example use of the arm pouch 200 of FIGS. 2A-2E according to the present disclosure.

As shown, in some implementations, a user (i.e., a person) inserts his or her folded arms into the interior 206 of the arm pouch 200, 500.

In some implementations, the user inserts the user's arms into the folded position within the interior 206 of the arm pouch. In some implementations, the user inserts the user's arms into the interior 206 through the opening 200a of the arm pouch 200.

In some implementations, the user adjusts the adjustment flap 204b of the arm pouch 200 to comfortably fit the user's arms in the interior 206 of the arm pouch 200. In some implementations, the user adjusts the adjustment flap 204b to fit the interior 206 of the arm pouch to the user's arms in the folded position within the interior 206.

In some implementations, the user adjusts the adjustment flap 204b by varying the attachment of the adjustment flap 204b to the back side 204 with the attaching portions 204b1.

In some implementations, adjusting the adjustment flap 204b comprises varying the attachment of the adjustment flap 204b to one of the various positions of the second layer of the back panel 204. In some implementations, varying the attachment of the adjustment flap 204b provides a manual adjustment of the length of the back panel 204 between the left side 208a and the right side 208b of the arm pouch 200.

In some implementations, the expandable portion 204a expands to help fit the interior 206 of the arm pouch to the user's folded arms. In some implementations, the expandable portion 204a contracts to help fit the interior 206 of the arm pouch 200 to the user's folded arms.

In some implementations, the arm pouch cradles the user's arms.

In some implementations, the arm pouch assists the user to maintain a folded arm position.

In some implementations, the arm pouch keeps the user's arms folded in place.

In some implementations, the arm pouch keeps the user's arms folded in place even when the user is asleep.

In some implementations, the arm pouch mimics how the user crosses his or her arms to have them rest.

In some implementations, the arm pouch allows the user to relax his or her arms by resting them in the arm pouch 200.

In some implementations, the arm pouch uses the natural weight of the user's arms to push outwards on the sides 202, 204 of the arm pouch 200 to hold the user's arms in place naturally against the user's body.

In some implementations, the arm pouch allows the user's arms to rest along the bottom side 208c of the arm pouch 200 within the interior 206.

The figures, including photographs and drawings, comprised herewith may represent one or more implementations of the arm pouch.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An arm pouch for holding, resting, and maintaining a person's arms in a folded position, the arm pouch having a pouch-like shape and comprising a front panel and a back panel that are connected together along a left side, a bottom side, and a right side of the arm pouch with respect to the front panel, wherein:
an interior of the arm pouch is defined between the front panel and the back panel;
an opening to the interior is defined along a top side of the arm pouch between the front panel and the back panel;
the back panel comprises a first layer and a second layer, wherein:
the first layer comprises an expandable portion extending at least partially between the left side and the right side of the arm pouch;
the expandable portion is configured to flexibly expand and contract to provide an expanding adjustment of a length of the back panel between the left side and the right side of the arm pouch to fit the interior of the arm pouch to the person's arms in the folded position within the interior;
the second layer comprises an adjustment flap extending at least partially between the left side and the right side of the arm pouch; and
the adjustment flap comprises attaching portions configured to allow the adjustment flap to be unattached from and attached to various positions of the second layer to provide a manual adjustment of the length of the back panel between the left side and the right side of the arm pouch to fit the interior of the arm pouch to the person's arms in the folded position within the interior;
the front panel and the back panel are composed of a flexible material;
the folded position of the person's arms comprises at least a portion of the person's arms positioned adjacently together in front of the person's body with the person's arms at least partially bent at the elbows; and
the arm pouch is configured to:
allow the person's arms to be inserted into the folded position within the interior of the arm pouch through the opening of the arm pouch;
contain the person's arms in the folded position within the interior of the arm pouch through the opening;
cradle the person's arms in the folded position within the interior of the arm pouch;
assist the person to maintain the person's arms in the folded position within the interior of the arm pouch;
keep the person's arms in the folded position within the interior of the arm pouch; and
allow the person to rest the person's arms in the folded position within the interior of the arm pouch.

2. The arm pouch of claim 1 wherein the arm pouch is configured so that the back panel positions adjacent to the person's body when the person's arms in the folded position are positioned in the interior of the arm pouch.

3. The arm pouch of claim 1 wherein the first layer is an inner layer and the second layer is an outer layer with respect to the interior of the arm pouch.

4. The arm pouch of claim 1 wherein the expandable portion of the first layer of the back panel comprises an elastic material.

5. The arm pouch of claim 1 wherein the attaching portions of the second layer of the back panel comprise one of a hook and loop attachment, a zipper, snaps, buttons, or magnets.

6. A method of using the arm pouch of claim 1, the method comprising:
inserting the person's arms into the folded position within the interior of the arm pouch through the opening of the arm pouch; and
adjusting the adjustment flap to fit the interior of the arm pouch to the person's arms in the folded position within the interior.

7. The method of claim 6 wherein adjusting the adjustment flap comprises varying the attachment of the adjustment flap to one of the various positions of the second layer of the back panel to provide a manual adjustment of the length of the back panel between the left side and the right side of the arm pouch.
